(19) United States
(12) Patent Application Publication
(10) Pub. No.: US 2015/0109543 A1
(43) Pub. Date: Apr. 23, 2015

(54) TOUCH PANEL

(71) Applicant: Samsung Display Co., Ltd., Yongin-City (KR)

(72) Inventor: Jung Sun LEE, Yongin-si (KR)

(73) Assignee: Samsung Display Co., Ltd., Yongin-City (KR)

(21) Appl. No.: 14/203,322

(22) Filed: Mar. 10, 2014

(30) Foreign Application Priority Data
Oct. 18, 2013 (KR) 10-2013-0124814

(51) Int. Cl. G06F 3/041; G06F 3/044

(52) U.S. Cl. CPC G06F 3/041; G06F 3/044
USPC 349/12

(57) ABSTRACT

A touch panel capable of inhibiting premature degradation of its touch sensing capacity is disclosed. One inventive aspect includes a first substrate, a touch sensor, a cover window and a shielding electrode. The touch sensor is positioned on a first surface of the first substrate and includes a touch electrode and a signal transfer wire. The signal transfer wire is positioned in the peripheral area and connected to the touch electrode in the touch area. The cover window covers the first substrate. The shielding electrode is positioned between the cover window and the signal transfer wire so as to electrically shield the signal transfer wire.

### CROSS-REFERENCE TO RELATED APPLICATIONS

This application claims priority to and the benefit of Korean Patent Application No. 10-2013-0124814 filed in the Korean Intellectual Property Office on Oct. 18, 2013, the entire contents of which are incorporated herein by reference.

### BACKGROUND

1. Field

The disclosed technology generally relates to a touch panel capable of inhibiting the early breakdown of its touch sensing capacity.

2. Description of the Related Technology

A display device, such as a liquid crystal display (LCD), an organic light emitting diode (OLED) display, and an electrophoretic display, includes a field generating electrode and an electro-optical active layer. A LCD includes a liquid crystal layer as the electro-optical active layer. An OLED display includes an organic emission layer as the electro-optical active layer. An electrophoretic display includes charged particles. The field generating electrode is connected to a switching element such as a thin film transistor to receive data signals, and the electro-optical active layer converts the data signals to an optical signal to display an image.

Recently, many display devices include touch sensing functionality in addition to its image display functionality. The touch sensors are used to identify touch information (such as whether an object approaches or touches a screen) and a touch location thereof by sensing changes in pressure, charges, light, and the like which are applied to the screen by the display device, when a user writes or draws using a finger or a touch pen. Moreover, the display device may receive an image signal based on the identified touch information to display a new image.

The touch sensing function of a display device is widely implemented via a set of touch sensors. The touch sensors can be implemented by various types of technologies, such as resistive, capacitive, electro-magnetic (EM), and optical.

Among various touch sensors, capacitive type touch sensors include a sensing capacitor formed by a plurality of sensing electrodes which transfers sensing signals. The capacitive type touch sensors can sense a change in charged capacitance or change in charge amount of the sensing capacitor generated when a conductor (such as a finger) approaches the touch sensor to determine existence of a touch, a touch position, and the like. The capacitive type touch sensors include a plurality of touch electrodes in a touch sensing area and signal transfer wires connected to the touch electrodes. The signal transfer wire transfers a sensing input signal to the touch electrode or transfer a touch output signal of the touch electrode generated according to a touch to a sensing signal controller.

These touch sensors can be formed in a touch panel to be attached on the display device (add-on cell type), formed outside the substrate of the display device (on-cell type), or formed inside the display device (in-cell type). A touch area in which the touch is performed and sensed may overlap with the display area in which an image is displayed. A panel including the touch sensor is commonly called a touch panel, and the touch panel may be a panel of the display device including the touch sensors, and may also be a panel attached to the display device.

Since the edges of the touch area extend along a peripheral area of the display, it permits the signal transfer wire to be connected to the sensing signal controller.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

When a user carries and uses the touch panel, the user uses the touch panel while gripping a peripheral area of the touch panel with a hand or other objects. In this case, a charge amount of the touch electrode connected to the signal transfer wire is changed by capacitance formed between the object such as a hand touching the peripheral area and the signal transfer wire formed in the peripheral area, and as a result, the touch sensing capacity in the touch area can prematurely degrade its functionality.

The disclosed technology has been made in an effort to provide a touch panel having advantages of preventing a touch sensing capacity of the touch panel having a capacitive touch sensing function from deteriorating even when a user uses the touch panel while gripping a peripheral area of the touch panel with a hand or other objects.

An exemplary embodiment of the disclosed technology provides a touch panel, including: a first substrate including a touch area and a peripheral area around the touch area, a touch sensor positioned on a first surface of the first substrate, a cover window covering the first substrate, and a shielding electrode positioned between the cover window and a signal transfer wire positioned in the peripheral area to shield the signal transfer wire. The touch sensor includes a touch electrode positioned in the touch area. The signal transfer wire positioned in the peripheral area and connected to the touch electrode.

The touch panel may further include an insulating film on which the shielding electrode is formed, in which the insulating film may be attached to an inner surface of the cover window via an optical transparent adhesive.

The shielding electrode may receive a ground voltage via a flexible printed circuit film.

The shielding electrode may be connected to the flexible printed circuit film via a conductive tape or an anisotropic conductive film.

The flexible printed circuit film may be connected to an icon positioned in the peripheral area.

The shielding electrode may be extended along the signal transfer wire positioned in the peripheral area.

The touch panel may further include an adhesive positioned between the shielding electrode and the touch sensor.

The shielding electrode may be deposited on the signal transfer wire positioned in the peripheral area.

The touch panel may further include an insulating layer positioned between the shielding electrode and the signal transfer wire.

The touch panel may further include an adhesive positioned between the shielding electrode and the cover window.

The flexible printed circuit film may include a touch sensing signal controller controlling the touch sensor.

The shield electrode is further configured to connect to a ground voltage terminal of the sensing signal controller via a flexible printed circuit film.

The shielding electrode may be positioned on an inner surface of the cover window.

A light blocking member may be positioned between the shielding electrode and the cover window, and the light blocking member may be positioned in the peripheral area.

The shielding electrode may include a conductive material including silver (Ag).

The touch electrode may further comprise a sensing input electrode and a sensing output electrode. The sensing input electrode and the sensing output electrode may be separated from each other.

The first substrate may comprise a lower substrate, an upper substrate facing the lower substrate, and a light emitting member positioned between the lower substrate and the upper substrate. The light emitting member is configured to emit lights toward the cover window.

The touch electrode may comprise a plurality of sensing electrodes arranged in a matrix form.

The touch area may comprise a sensing capacitor, and wherein the shield electrode is further configured to prevent a change in capacitance and charge amount of the sensing capacitor through the signal transfer wire.

According to some exemplary embodiments of the disclosed technology, it is possible to prevent a touch sensing capacity in the touch area from deteriorating by blocking a space between an object such as a hand and a signal transfer wire positioned in the peripheral area of the touch panel even though a user uses the touch panel while gripping a peripheral area of the touch panel with a hand or other objects.

### BRIEF DESCRIPTION OF THE DRAWINGS

FIG. 1 is a block diagram of a touch panel according to an exemplary embodiment of the disclosed technology.

FIGS. 2 and 3 are cross-sectional views of touch electrodes included in the touch panel according to some exemplary embodiments of the disclosed technology, respectively.

FIG. 4 is a front perspective view of the touch panel according to an exemplary embodiment of the disclosed technology.

FIG. 5 is a cross-sectional view of the touch panel of FIG. 4 taken along line V-V.

FIG. 6 is a cross-sectional view of the touch panel according to an exemplary embodiment of the disclosed technology.

FIG. 7 is a front perspective view of the touch panel according to an exemplary embodiment of the disclosed technology.

FIG. 8 is a cross-sectional view of the touch panel of FIG. 7 taken along line VIII-VIII.

### DETAILED DESCRIPTION OF CERTAIN INVENTIVE EMBODIMENTS

The disclosed technology will be described more fully hereinafter with reference to the accompanying drawings, in which exemplary embodiments of the invention are shown. As those skilled in the art would realize, the described embodiments may be modified in various different ways, all without departing from the spirit or scope of the disclosed technology.

Accordingly, the drawings and description are to be regarded as illustrative in nature and not restrictive. Like reference numerals designate like elements throughout the specification.

In the drawings, the thickness of layers, films, panels, regions, etc., are exaggerated for clarity. In the drawings, for better understanding and ease of description, the thicknesses of some layers and areas are exaggerated. It will be understood that when an element such as a layer, film, region, or substrate is referred to as being “on” another element, it may be directly on the other element or intervening elements may also be present.

Throughout this specification and the claims that follow, when it is described that an element is “connected” to another element, the element may be “directly connected” to the other element or “electrically connected” to the other element through a third element. In addition, unless explicitly described to the contrary, the word “comprise” and variations such as “comprises” or “comprising” will be understood to imply the inclusion of stated elements but not the exclusion of any other elements. Throughout this specification, it is understood that the term “on” and similar terms are used generally and are not necessarily related to a gravitational reference.

Here, when a first element is described as being connected to a second element, the first element may be not only directly connected to the second element but may also be indirectly connected to the second element via a third element. Further, some of the elements that are not essential to the complete understanding of the disclosed technology are omitted for clarity. Also, like reference numerals refer to like elements throughout.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

Hereinafter, a touch panel according to an exemplary embodiment of the disclosed technology will be described in detail with reference to the accompanying drawings.

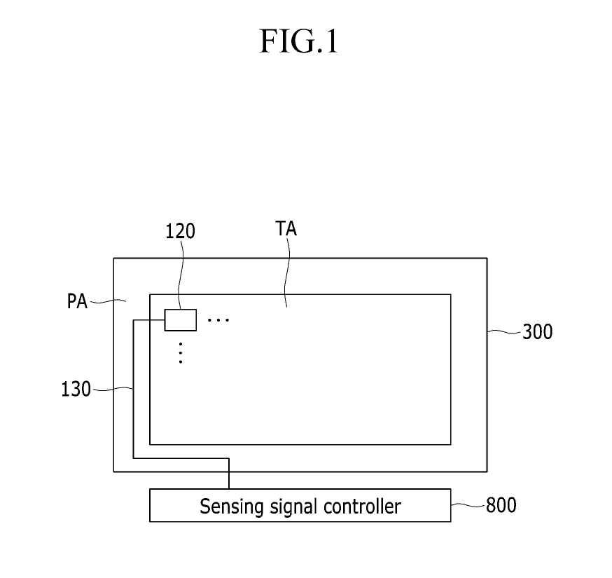

First, a touch panel according to an exemplary embodiment of the disclosed technology will be described with reference to FIGS. 1 to 3.

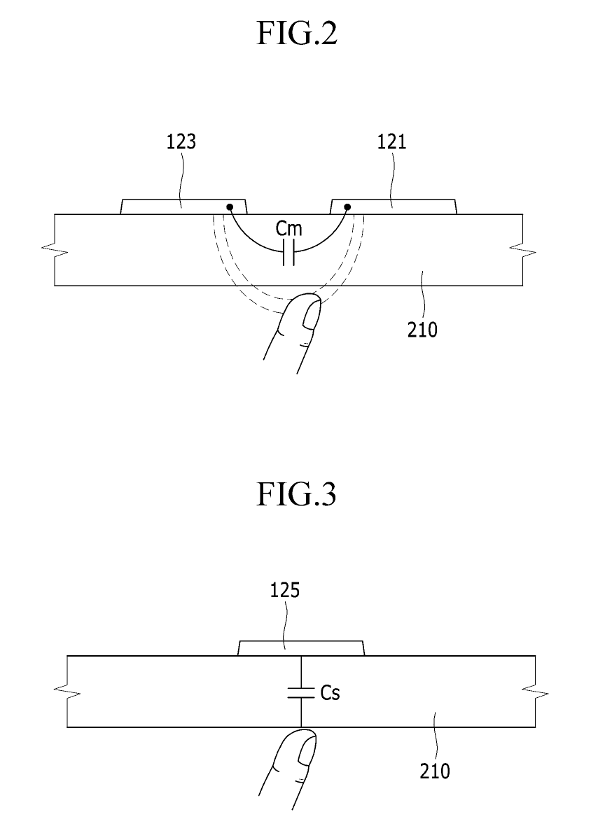

FIG. 1 is a block diagram of a touch panel according to an exemplary embodiment of the disclosed technology, and FIGS. 2 and 3 are cross-sectional views of touch electrodes included in the touch panel according to the exemplary embodiment of the disclosed technology, respectively.

Referring to FIG. 1, a touch panel 300 according to an exemplary embodiment of the disclosed technology includes a touch sensor capable of sensing a touch of an external object such as a hand and a pen. The touch sensor may be formed in a separate panel to be attached on a display panel of a display device such as a liquid crystal display (LCD), an organic light emitting diode (OLED) display (add-on cell type), formed outside a substrate configuring the display device (on-cell type), or formed inside the display panel of the display device (in-cell type).

The display panel including the touch sensor, the separate panel, and the like are commonly called a touch panel 300.

Referring to FIG. 1, the touch panel 300 according to some exemplary embodiment of the disclosed technology includes a touch area TA, and a peripheral area PA therearound.

The touch area TA is an area capable of sensing a touch when an object actually approaches or touches the touch panel 300. The touch area TA may overlap with a display area in which an image is displayed. Here, the touch includes not only a case where an external object such as a user's hand directly contacts the touch panel 300 but also a case where the external object approaches the touch panel 300 or hovers while approaching the touch panel 300.

A plurality of touch electrodes 120 and a signal transfer wire 130 are positioned in the touch area TA. The touch electrodes 120 may be arranged in a matrix form, but is not limited thereto. The signal transfer wire 130 is connected with the touch electrode 120 to transfer a sensing input signal or a sensing output signal.

A plurality of signal transfer wires 130 extended from the touch area TA is positioned in the peripheral area PA. The signal transfer wire 130 is connected to a sensing signal controller 800. The sensing signal controller 800 controls the touch sensor to transfer the sensing input signal or the sensing output signal. A light blocking member (not illustrated) through which light does not pass may be positioned in the peripheral area PA.

The touch electrode 120 and the signal transfer wire 130 connected thereto configure the touch sensor together.

The touch sensor may sense a touch of various types. In one exemplary implementation, the touch sensor is classified into various types such as a resistive type, a capacitive type, an electro-magnetic (EM) type, and an optical type.

In some exemplary embodiments, a capacitive touch sensor will be described as a non-limiting example.

Referring to FIG. 2, the touch electrodes 120 according to an exemplary embodiment of the disclosed technology include a plurality of sensing input electrodes 121 and a plurality of sensing output electrodes 123. The sensing input electrode 121 and the sensing output electrode 123 are separated from each other.

The sensing input electrodes 121 arranged in the same row or column may be connected to each other inside or outside the touch area TA. The sensing input electrodes 121 arranged in the same row or column may be separated from each other inside or outside the touch area TA. Similarly, at least some of the sensing output electrodes 123 arranged in the same row or column may be connected to each other inside or outside the touch area TA. Also similarly, at least some of the sensing output electrodes 123 arranged in the same row or column may be separated from each other inside or outside the touch area TA. In one exemplary implementation, when the sensing input electrodes 121 arranged in the same row is connected to each other inside or outside the touch area TA, the sensing output electrodes 123 arranged in the same column may be connected to each other inside or outside the touch area TA.

The sensing input electrode 121 and the sensing output electrode 123 are adjacent to each other form a sensing capacitor Cm. The sensing capacitor Cm serves as a touch sensor. The sensing capacitor Cm may be a mutual sensing capacitor. The sensing capacitor Cm may receive the sensing input signal through the sensing input electrode 121. The sensing capacitor Cm may output a change in charge amount by touching of the external object as a sensing output signal through the sensing output electrode 123.

The sensing input electrode 121 and the sensing output electrode 123 may be formed on an outer surface of an upper substrate 210 of the touch panel 300, but are not limited thereto. The sensing input electrode 121 and the sensing output electrode 123 may be positioned on the same layer or on different layers.

The sensing input electrode 121 and sensing output electrode 123 may be made of transparent conductive material such as indium tin oxide (ITO), indium zinc oxide (IZO), and a thin metal layer, but are not limited thereto.

Referring to FIG. 3, the touch electrodes 120 according to the exemplary embodiment of the disclosed technology include a plurality of sensing electrodes 125. The sensing electrodes 125 may be arranged in a matrix form.

Each sensing electrode 125 may form a self sensing capacitor Cs as a touch sensor. The self sensing capacitor Cs receives the sensing input signal to be charged by a predetermined charge amount. The self sensing capacitor Cs may output a sensing output signal different from the sensing input signal inputted by a change in charge amount generated when the external object such as a finger touches. As such, touch information such as existence of the touch and a touch position may be determined based on the changed sensing output signal.

The sensing electrode 125 may be formed on an outer surface of the upper substrate 210 of the touch panel 300, but is not limited thereto.

The sensing signal controller 800 controls the touch sensor. The sensing signal controller 800 may transfer the sensing input signal to the touch electrode 120 through the signal transfer wire 130 or receive the sensing output signal. The sensing signal controller 800 processes the sensing output signal to generate the touch information such as existence of the touch and a touch position. The sensing signal controller 800 may be mounted on a flexible printed circuit film in an IC chip form to be attached to the touch panel 300 or mounted on a separate printed circuit substrate, but is not limited thereto.

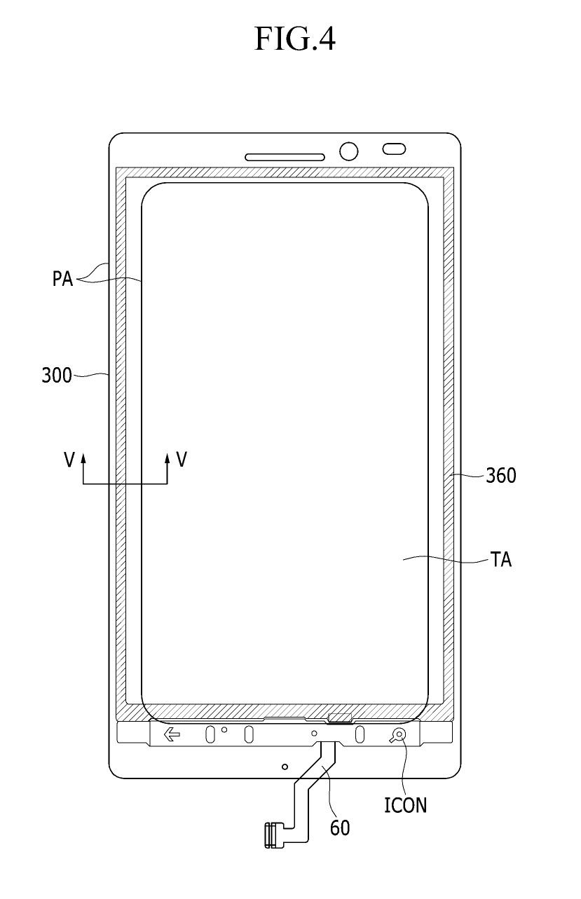

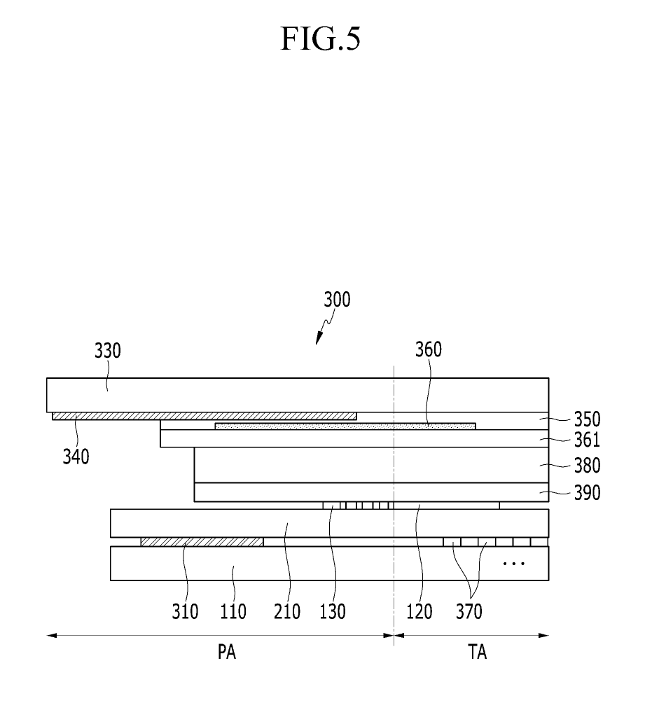

Then, a detailed structure of the touch panel according to some exemplary embodiments of the disclosed technology will be described with reference to FIGS. 4 and 5 together with the drawings described above.

FIG. 4 is a front perspective view of a touch panel according to an exemplary embodiment of the disclosed technology, and FIG. 5 is a cross-sectional view of the touch panel of FIG. 4 taken along line V-V.

Since the touch panel according to some exemplary embodiments is almost the same as the touch panel according to the exemplary embodiments illustrated in FIGS. 1 to 3 described above, constituent elements which are not described above will be mainly described.

Referring to FIGS. 4 and 5, the touch panel 300 according to the exemplary embodiment of the disclosed technology includes an upper substrate 210, a touch sensor, a cover window 330, and a shielding electrode 360.

The upper substrate 210 may be a flexible substrate as a substrate including an insulating material such as glass or plastic.

The touch sensor may be positioned on an outer surface or an inner surface of the upper substrate 210. FIG. 5 illustrates an exemplary implementation in which the touch sensor is positioned on the outer surface of the upper substrate 210. The touch sensor includes the touch electrodes 120 and the signal transfer wire 130 connected thereto as described above. The touch electrodes 120 are positioned in the touch area TA, and the signal transfer wire 130 is positioned in the touch area TA and the peripheral area PA.

The cover window 330 is positioned at the outermost side of the touch panel 300. The cover window 330 may cover the upper substrate 210. The cover window 330 may be made of a transparent material such as tempered glass.

Referring to FIGS. 4 and 5, the shielding electrode 360 is positioned on an inner surface of the cover window 330. The shielding electrode 360 is mainly positioned in the peripheral area PA as illustrated in FIG. 4. However, when the shielding electrode 360 includes a transparent conductive material, a part of the shielding electrode 360 may be positioned in the touch area TA as illustrated in FIG. 5.

The shielding electrode 360 may include a conductive material such as ITO, IZO, or metal.

The shielding electrode 360 is extended along the signal transfer wire 130 of the peripheral area PA to form substantially a closed curve, as illustrated in FIG. 4.

The shielding electrode 360 covers the signal transfer wire 130 positioned in the peripheral area PA of the touch sensor to shield the external object such as a hand. The shielding electrode 360 may covers a space between the signal transfer wire 130 and the external object. Accordingly, when the external object such as a hand touches the peripheral area PA of the touch panel 300, a parasite capacitance between the signal transfer wire 130 and the external object is not formed and the signal of the signal transfer wire 130 is not affected. As a result, the capacitance and the charge amount of the sensing capacitor generated by the touch panel 120 may not be influenced by the external object when a hand touches the peripheral area PA. The touch panel 120 is connected with the signal transfer wire 130. Therefore, the touch sensing capacity of the touch sensor in the touch area TA does not deteriorate, but the touch sensor may normally sense the touch.

Particularly, when hovering detecting sensing movement while the external object approaches the touch area TA is performed, the touch sensing result is very sensitive to the change in capacitance and charge amount of the sensing capacitor. When the change in capacitance and charge amount of the sensing capacitor is generated by the touch in the peripheral area PA, the hovering detecting capacity in the touch area TA may deteriorate. However, according to some exemplary embodiments of the disclosed technology, the shielding electrode 360 is positioned between the signal transfer wire 130 of the peripheral area PA and the cover window 330. The shielding electrode 360 may prevent a change in capacitance and charge amount of the sensing capacitor of the touch area TA through the signal transfer wire 130. The shielding electrode 360 may also prevent the hovering detecting capacity in the touch area TA from deteriorating.

The shielding electrode 360 may be formed on an insulating film 361 and then be attached to the inner surface of the cover window 330 as illustrated in FIG. 5. The insulating film 361 may be a film including a plastic material such as polyethylene ether terephthalate (PET), polyethylene naphthalate, and polycarbonate. In this case, as illustrated in FIG. 5, the shielding electrode 360 may be positioned between the cover window 330 and the insulating film 361. The insulating film 361 may also be positioned between the cover window 330 and the shielding electrode 360.

The insulating film 361 with the shielding electrode 360 may be attached to the inner surface of the cover window 330 by using an adhesive 350 such as an optical clear adhesive (OCA).

The shielding electrode 360 may receive a ground voltage GND.

Referring to FIG. 4, in the touch panel 300 according to some exemplary embodiments of the disclosed technology, an icon ICON is positioned in the peripheral area PA. The shielding electrode 360 may be connected to a ground voltage terminal of the sensing signal controller 800 via a flexible printed circuit film 60. The icon ICON is connected to the flexible printed circuit film 60. The shielding electrode 360 may be connected to the flexible printed circuit film 60 via a conductive film such as an anisotropic conductive film (ACF), a conductive tape, or the like.

Referring to FIG. 5, the touch panel 300 according to some exemplary embodiments of the disclosed technology is an organic light emitting diode display. In this case, the upper substrate 210 faces a lower substrate 110. A light emitting member 370 may be positioned between the upper substrate 210 and the lower substrate 110. The light emitting member 370 may be positioned between a pixel electrode (not illustrated) and a common electrode (not illustrated) which face each other. The light emitting member 370 may include at least one organic common layer (not illustrated) and a light emission layer (not illustrated). The light emission layer may be positioned on the pixel electrode in each corresponding pixel. The light emission layer corresponding to each pixel may include an organic material which uniquely emits light of the primary colors such as red, green, and blue.

In the exemplary embodiment illustrated in FIG. 5, the light emitting member 370 emits the light toward the cover window 330 to display an image.

The lower substrate 110 and the upper substrate 210 may be coupled with each other via a sealant 310 positioned in the peripheral area PA.

An anti-reflective layer 390 for improving visibility by reducing external light reflection may be attached onto the outer surface of the upper substrate 210. The anti-reflective layer 390 may include a polarizer (not illustrated) or a plurality of thin film layers (not illustrated). In the case where the anti-reflective layer 390 includes the thin film layers, the thin film layers may include at least one metal thin film layer and at least one dielectric layer which are alternately laminated.

The cover window 330 with the shielding electrode 360 may be attached onto the upper substrate 210 by using the adhesive 380. The adhesive 380 may include a resin. In this case, the liquid resin is coated on the inner surface of the cover window 330, the cover window 330 is bonded with the upper substrate 210, and then light such as an ultraviolet ray is irradiated to the resin, thereby curing the resin.

The light blocking member 340 may be positioned in an area of the inner surface of the cover window 330 corresponding to the peripheral area PA. The light blocking member 340 may be formed by coating black ink on the inner surface of the cover window 330.

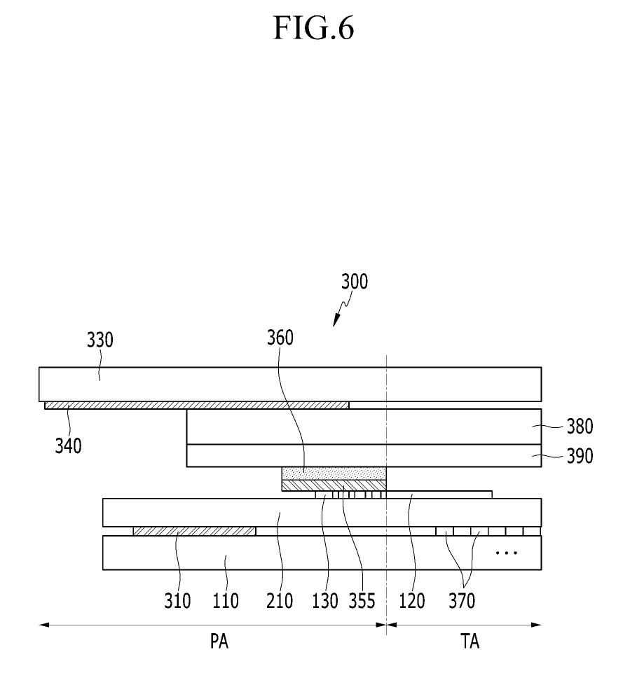

Next, a detailed structure of a touch panel according to an exemplary embodiment of the disclosed technology will be described with reference to FIG. 6 together with the drawings described above.

FIG. 6 is a cross-sectional view of a touch panel according to an exemplary embodiment of the disclosed technology.

Since the touch panel according to the exemplary embodiment is almost the same as the touch panels according to the exemplary embodiments illustrated in FIGS. 1 to 5 described above, here, differences will be mainly described.

Referring to FIG. 6, the touch panel 300 according to the exemplary embodiment of the disclosed technology is almost the same as the touch panel 300 according to the exemplary embodiment illustrated in FIGS. 4 and 5 described above, but a position of the shielding electrode 360 may be different. Further, the insulating film 361 may not be positioned on the inner surface of the cover window 330.

According to some exemplary embodiments, the shielding electrode 360 may be positioned between the signal transfer wire 130 in the peripheral area PA and at least one of the anti-reflective layer 390 or the adhesive 380. In this case, the insulating layer 355 is positioned between the shielding electrode 360 and the signal transfer wire 130.

The insulating layer 355 is coated on the signal transfer wire 130 in the peripheral area PA. A conductive material such as ITO, IZO, and metal is laminated and patterned thereon to form the shielding electrode 360.

The shielding electrode 360 is connected to the ground voltage terminal of the sensing signal controller 800 via a flexible printed circuit film or a printed circuit substrate to receive a ground voltage GND. The sensing signal controller 800 is mounted the flexible printed circuit film or the printed circuit substrate. The shielding electrode 360 may be connected to the flexible printed circuit film or the printed circuit substrate via a conductive film such as an anisotropic conductive film (ACF), a conductive tape, or the like.

As such, when the shielding electrode 360 is directly deposited on the signal transfer wire 130 in the peripheral area PA, a shielding effect between the external object touching the peripheral area PA and the signal transfer wire 130 may be further increased.

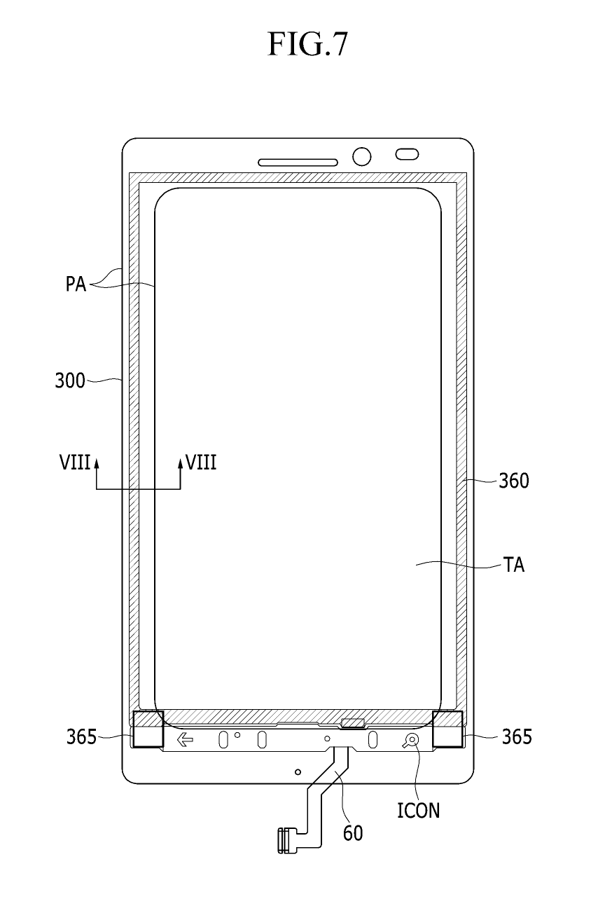

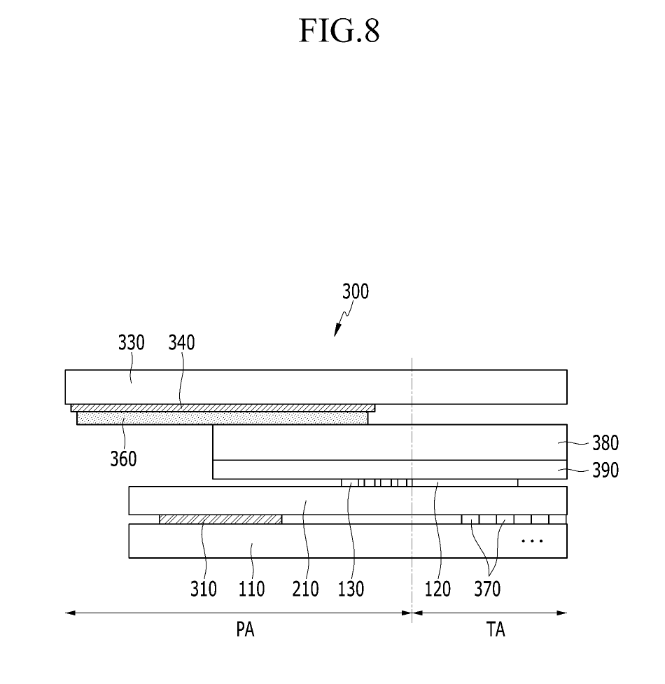

Next, a detailed structure of a touch panel according to an exemplary embodiment of the disclosed technology will be described with reference to FIGS. 7 and 8 together with the drawings described above.

FIG. 7 is a front perspective view of a touch panel according to an exemplary embodiment of the disclosed technology. FIG. 8 is a cross-sectional view of the touch panel of FIG. 7 taken along line VIII-VIII.

Since the touch panel according to the exemplary embodiment is almost the same as the touch panels according to the exemplary embodiments illustrated in FIGS. 1 to 5 described above, here, differences will be mainly described.

Referring to FIGS. 7 and 8, the touch panel 300 according to the exemplary embodiment of the disclosed technology is almost the same as the touch panel 300 according to the exemplary embodiment illustrated in FIGS. 4 and 5 described above, but a position of the shielding electrode 360 may be different. Further, the touch panel 300 according to some exemplary embodiments does not include the insulating film 361 according to the exemplary embodiment illustrated in FIGS. 4 and 5.

According to the exemplary embodiment, the shielding electrode 360 may be directly deposited on the inner surface of the cover window 330. In detail, the shielding electrode 360 may be formed by coating a conductive material such as silver (Ag) on the light blocking member 340 of the cover window 330. In this case, the shielding electrode 360 may be deposited and patterned on the inner surface of the cover window 330 by using a sputtering method.

Referring to FIG. 7, the shielding electrode 360 may be connected to a ground signal terminal of the sensing signal controller 800 via the flexible printed circuit film 60. The icon is connected to the flexible printed circuit film 60. The shielding electrode 360 may be connected to the flexible printed circuit film 60 via a conductive tape 365 or a conductive film such as an anisotropic conductive film (ACF) positioned around the icon ICON in the peripheral area PA.

As such, when the shielding electrode 360 is directly deposited on the inner surface of the cover window 330, an increase in thickness due to the shielding electrode 360 is reduced.

For purposes of summarizing the disclosed technology, certain aspects, advantages and novel features of the disclosed technology have been described herein. It is to be understood that not necessarily all such advantages may be achieved in accordance with any particular embodiment of the disclosed technology. Thus, the disclosed technology may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the disclosed technology. Thus, the disclosed technology is not intended to be limited to the embodiments shown herein but is to be accorded the widest scope consistent with the principles and novel features disclosed herein.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, those skilled in the art can easily select and substitute the drawings and disclosed description. Those skilled in the art can omit some of the constituent elements described in the present specification without deterioration in performance thereof or can add constituent elements to improve performance thereof. Furthermore, those skilled in the art can modify the sequence of the steps of the method described in the present specification depending on the process environment or equipment. Therefore, the scope of the disclosed teachology must be determined by the scope of the claims and the equivalent, not by the described embodiments.

What is claimed is:

1. A touch panel, comprising:
a first substrate including a touch area and a peripheral area around the touch area;
a touch sensor positioned on a first surface of the first substrate, the touch sensor including a touch electrode and a signal transfer wire, wherein the touch electrode is positioned in the touch area, and wherein the signal transfer wire is positioned in the peripheral area and connected to the touch electrode;
a cover window covering the first substrate; and
a shielding electrode positioned between the cover window and the signal transfer wire and configured to electrically shield the signal transfer wire.

2. The touch panel of claim 1, further comprising an insulating film on which the shielding electrode is formed, wherein the insulating film is attached to an inner surface of the cover window via an optical transparent adhesive.

3. The touch panel of claim 2, wherein the shielding electrode receives a ground voltage via a flexible printed circuit film.

4. The touch panel of claim 3, wherein the shielding electrode is connected to the flexible printed circuit film via a conductive tape or an anisotropic conductive film.

5. The touch panel of claim 4, wherein the flexible printed circuit film is connected to an icon positioned in the peripheral area.

6. The touch panel of claim 2, wherein the shielding electrode is extended along the signal transfer wire positioned in the peripheral area.

7. The touch panel of claim 2, further comprising an adhesive positioned between the shielding electrode and the touch sensor.

8. The touch panel of claim 1, wherein the shielding electrode is deposited on the signal transfer wire positioned in the peripheral area.

9. The touch panel of claim 8, further comprising an insulating layer positioned between the shielding electrode and the signal transfer wire.

10. The touch panel of claim 9, further comprising an adhesive film provided between the shielding electrode and the cover window.

11. The touch panel of claim 10, wherein the shielding electrode receives a ground voltage via a flexible printed circuit film.

12. The touch panel of claim 11, wherein the shielding electrode is connected to the flexible printed circuit film via a conductive tape or an anisotropic conductive film.

13. The touch panel of claim 12, wherein the flexible printed circuit film includes a touch sensing signal controller controlling the touch sensor.

14. The touch panel of claim 13, wherein the shield electrode is further configured to connect to a ground voltage terminal of the sensing signal controller via a flexible printed circuit film.

15. The touch panel of claim 8, wherein the shielding electrode extends along the signal transfer wire positioned in the peripheral area.

16. The touch panel of claim 1, wherein the shielding electrode is positioned on an inner surface of the cover window.

17. The touch panel of claim 16, wherein a light blocking member is positioned between the shielding electrode and the cover window, and wherein the light blocking member is positioned in the peripheral area.

18. The touch panel of claim 17, wherein the shielding electrode includes a conductive material formed of silver (Ag).

19. The touch panel of claim 18, wherein the shielding electrode receives a ground voltage via a flexible printed circuit film.

20. The touch panel of claim 19, wherein the shielding electrode is connected to the flexible printed circuit film via a conductive tape or an anisotropic conductive film.

21. The touch panel of claim 20, wherein the flexible printed circuit film is connected to an icon positioned in the peripheral area.

22. The touch panel of claim 1, wherein the touch electrode comprises a sensing input electrode and a sensing output electrode, and wherein the sensing input electrode and the sensing output electrode are separated from each other.

23. The touch panel of claim 1, wherein the first substrate comprises:
a lower substrate;
an upper substrate facing the lower substrate; and
a light emitting member positioned between the lower substrate and the upper substrate and configured to emit lights toward the cover window.

24. The touch panel of claim 1, wherein the touch electrode comprises a plurality of sensing electrodes arranged in a matrix form.

25. The touch panel of claim 1, wherein the touch area further comprises a sensing capacitor, and wherein the shield electrode is further configured to prevent a change in capacitance and charge amount of the sensing capacitor through the signal transfer wire.
